(19) United States
(12) Patent Application Publication
(10) Pub. No.: US 2006/0239234 A1
(43) Pub. Date: Oct. 26, 2006

(54) Application programming interface for discovering endpoints in a serverless peer to peer network

(75) Inventors: Ravi Rao, Redmond, WA (US); Eliot John Flannery, Redmond, WA (US); Tomer Weisberg, Bellevue, WA (US); Upshur Warren Parks III, Bothell, WA (US); Rohit Gupta, Redmond, WA (US); Kevin R. Tao, Kirkland, WA (US); Anirudh Anirudh, Redmond, WA (US); David G. Thaler, Redmond, WA (US); Andre R. Classen, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/112,133

(22) Filed: Apr. 22, 2005

(51) Int. Cl. H04Q 7/24

(52) U.S. Cl. 370/338; 370/401

(57) ABSTRACT

Methods are described that facilitate presence publication which may include authorizing publication of presence at a first endpoint, if the publication is authorized, assembling a presence data structure, and broadcasting the presence data structure from the first endpoint. The method may also include the presence structure including a friendly name, contact information, and endpoint information. The method further including contact information in at least one of XML format, vCard format, and the endpoint information obtained from a peer name resolution protocol. The method may additionally include the presence data structure encoded as at least one of a generic discovery protocol message, a simple service discovery protocol message, and associating a globally unique identifier with the discovery protocol messages. The method may include a user entity authorizing presence publication, the user entity setting at least one of a default parameter authorizing publication of all presence, some presence, or no presence.

### CROSS-REFERENCES TO RELATED APPLICATIONS

The subject matter of the present application is generally related to the following commonly-owned applications filed on the same day as the present application:

U.S. patent application Ser. No. ______ (Attorney Docket No. 30835/312452), entitled “PRESENCE MONITORING IN A SERVERLESS PEER-TO-PEER SYSTEM”;

U.S. patent application Ser. No. ______ (Attorney Docket No. 30835/312443), entitled “CONTACT MANAGEMENT IN A SERVERLESS PEER-TO-PEER SYSTEM”; and

U.S. patent application Ser. No. ______ (Attorney Docket No. 30835/312449), entitled “AN APPLICATION PROGRAMMING INTERFACE FOR DISCOVERING ENDPOINTS IN A SERVERLESS PEER TO PEER NETWORK”.

These applications are hereby incorporated by reference herein in their entireties for all purposes.

### BACKGROUND

Server based communication services such as the Messenger service provided by MSN® communication services permit users to sign into a server-based network and then use the services of the network (e.g., e-mail, text messaging, etc.). A server may store a contact list for the user and the user can add and delete persons from the contact list. When the user signs in, a server or servers may notify persons in the user's contact list that the user is “online.” Similarly, the server or servers may notify the user of persons in the user's contact list that are “online.”

The MICROSOFT® Corporation also provides Peer-to-Peer Networking software for use with its WINDOWS® operating systems. With this system, users can create a network of peer computers and can communicate with one another without having to sign into a central server. For example, users can create a peer-to-peer group and then create a chat room in which all members of the group can post messages and see messages posted by others in the group. The system may also allow peers to discover other peers nearby. The chat room is maintained using the peer computers and without the need for a central server.

### SUMMARY

Methods are described that facilitate presence publication which may include authorizing publication of presence at a first endpoint, if the publication is authorized, assembling a presence data structure, and broadcasting the presence data structure from the first endpoint. The method may also include the presence structure including a friendly name, contact information, and endpoint information. The method further including contact information in at least one of XML format, vCard format, and the endpoint information obtained from a peer name resolution protocol. The method may additionally include the presence data structure encoded as at least one of a generic discovery protocol message, a simple service discovery protocol message, and associating a globally unique identifier with the discovery protocol messages. The method may include a user entity authorizing presence publication, the user entity setting at least one of a default parameter authorizing publication of all presence, some presence, or no presence.

Methods are described that facilitate discovering user entities, including registering a first user entity at a first endpoint, receiving messages identifying a second user entity, validating the received messages, and storing the validation results in a discovery cache. The method may also include registering including publishing simple service discovery protocol messages, enumerating results of the discovery cache, and querying for a second user entity. The method may further include the received messages in XML format, the received messages including presence information, the presence information further including status of a second endpoint of the second user entity, contact identity information of the second user entity, and contact metadata of the second user entity. The method may further include validation including identifying messages that indicate at least one of available user entities, unavailable user entities, adding available user entities to the discovery cache and removing unavailable user entities from the discovery cache. The method may include messages encoded as simple service discovery protocol messages, associating a globally unique identifier with the simple service discovery protocol messages, and registering including permitting the first user entity to participate in message reception.

### DRAWINGS

FIG. 1 is a block diagram of a computing system that may operate in accordance with the claims;

FIG. 2 is a block diagram of an exemplary system that may facilitate peer-to-peer, serverless collaboration and/or communications;

FIG. 3 is a flow diagram of an exemplary method related to publishing availability in a serverless peer-to-peer network; and

FIG. 4 is a flow diagram of an exemplary method related to discovering people near me in a serverless peer-to-peer network.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

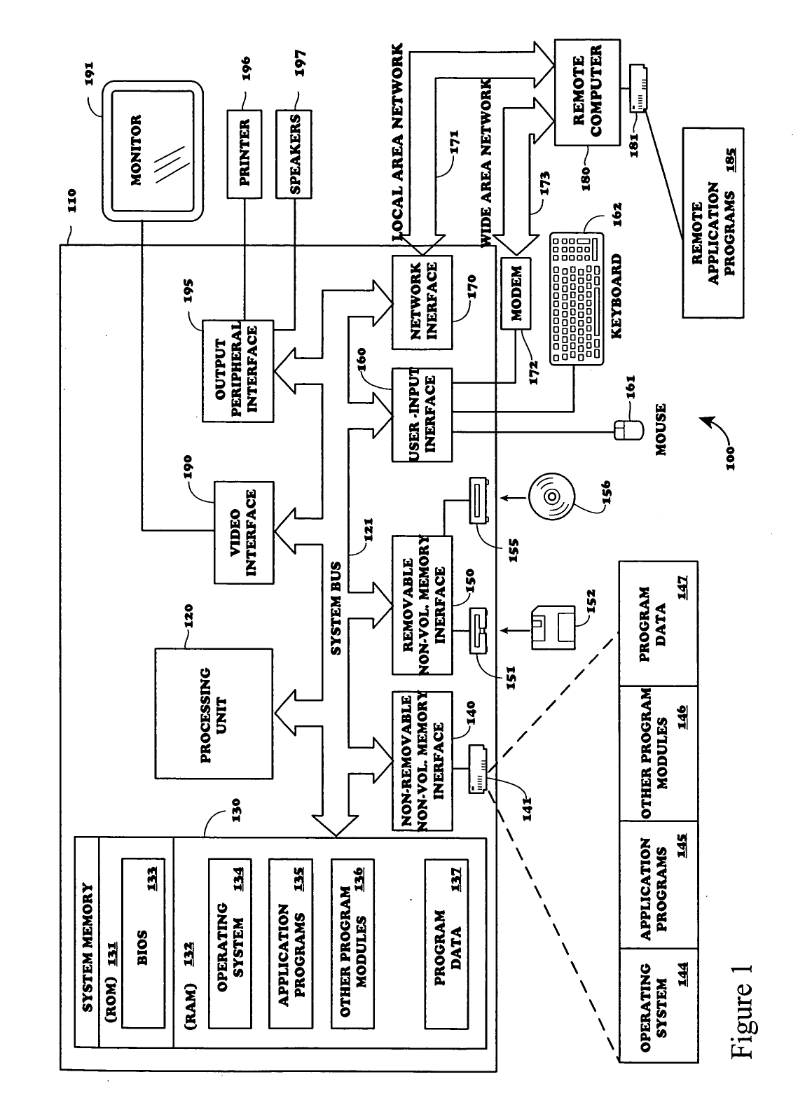

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

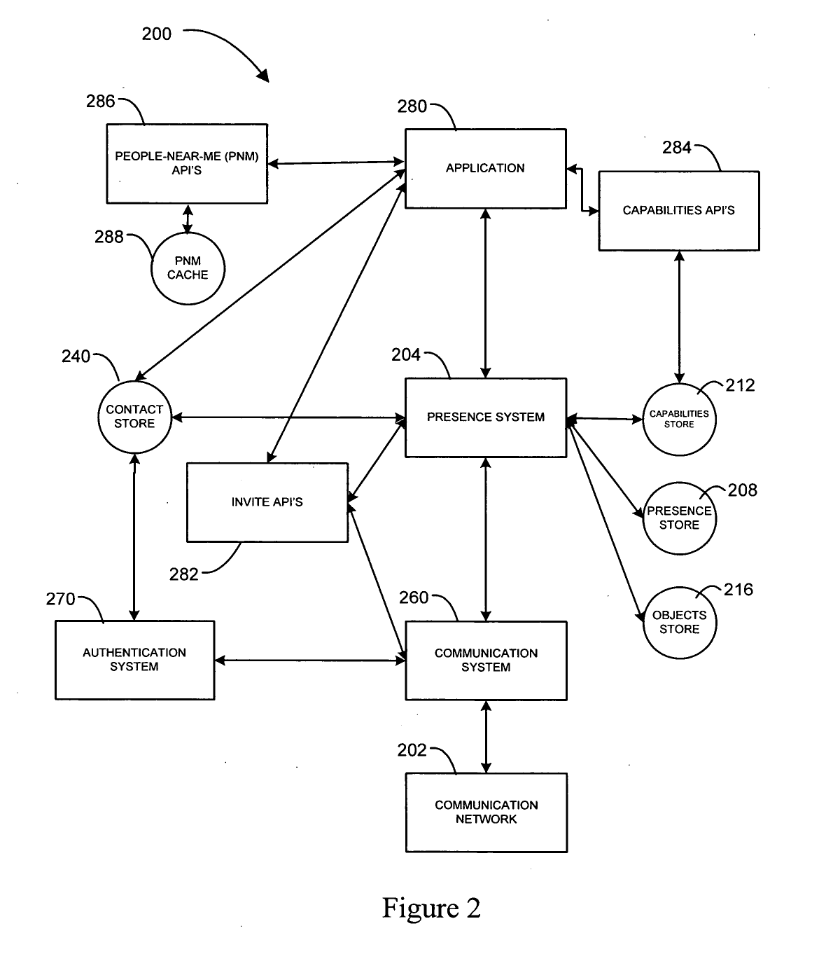

FIG. 2 is a block diagram of an example system 200 that may be used to implement example methods described herein. The system 200 may facilitate peer-to-peer, serverless collaboration and/or communications via a communication network 202, and may be implemented using a computing system such as the computing system 100 of FIG. 1. The communication network may include, but is not limited to, a LAN and/or a WAN, or a communication medium supporting socket communications, or named-pipes, for example.

The system 200 may include a presence system 204 that monitors the presence of other entities on the communication network. An entity may be, for example, a particular person, a device (e.g., a printer, a copier, a computer, a scanner, etc.) a position in an organization (e.g., “manager,” “customer service representative,” etc.), an organization, etc. Presence on a network may generally refer to a current status of an entity with regard to their willingness or ability to communicate via the network, but may also refer to additional or alternative information regarding the entity such as a current activity of the entity. Presence on a network may be represented by presence information. Examples of presence information may include, but are not limited to, one or more of an indication that an entity is “online,” an indication that an entity is “out to lunch,” an indication that an entity is “away,” an indication that an entity will “be right back,” an indication that an entity is “idle,” an indication that an entity is “busy,” an indication that an entity is “on the phone,” an indication that an entity is “watching a movie,” an indication that an entity is “playing Halo®,” an indication that an entity is “helping another customer,” an indication of a device status (e.g., a printer with status “busy,” “idle,” etc). Presence information may include one or more enumerated strings and/or rich presence (e.g., custom strings generated by a user entity). For example, a user entity could define a custom presence state as, “I am out of the office. Will return tomorrow.” Presence information obtained by the presence system 204 may be stored in a presence store 208.

The presence system 204 may facilitate a user entity to monitor (or “subscribe”) to presence information of other entities. This may include the presence system 204 polling other computing systems periodically, for example. Additionally or alternatively, other computing systems corresponding to other user entities may transmit event indications to the system 200 that notify the presence system 204 of events such as a change in presence state. For example, an event may occur when a user's presence changes from “offline” to “online,” and the presence system 204 may detect this event. The presence system 204 could then notify other applications or software modules (e.g., such as the application 280) that the event occurred.

The presence system 204 may also monitor capabilities of other entities published on the network 202. Capabilities of an entity may include, for example, static capabilities such as whether a computing system of the entity is configured to execute a particular software application, whether a computing system of the entity has a particular hardware device, etc. Capabilities of an entity may also include, for example, dynamic capabilities such as real-time capabilities of an entity with respect to a game software application currently being executed on the entity's computing system, etc. An entity publishing capabilities on the network may refer to permitting other entities to be able to monitor the capabilities via the network 202. Capability information obtained by the presence system 204 may be stored in a capability store 212.

The presence system 204 may also monitor objects of other entities published on the network 202. Objects of an entity may include, for example, data objects such as files, structures, pictures, sounds, a description such as meta-data, a name-value pair, etc. An entity publishing objects on the network may refer to permitting other entities to be able to monitor the objects via the network 202. As just one example, publishing an object may permit an entity to provide other entities with information specific to an application being executed by a computing system of the entity and/or real-time information. With respect to a game application, for instance, a published object could include information regarding a player's current score, a weapon currently in possession of the player, etc. Objects information obtained by the presence system 204 may be stored in an objects store 216.

The presence system 204 may also provide (or “publish”) presence information associated with a user entity (i.e., the entity associated with the system 200) to other entities on the network 202. The presence information associated with the user entity may be stored in the presence store 208 or some other storage. Similarly, the presence system 204 may also provide (or “publish”) information regarding capabilities of the user entity to other entities on the network 202. The capability information associated with the user entity may be stored in a capability store 208. Further, the presence system 204 may also provide (or “publish”) information regarding objects of the user entity to other entities on the network. The object information associated with the user entity may be stored in an object store 216, or some other storage. Similarly, the presence system 204 may facilitate an ability for the user entity to monitor (or “subscribe-to”) presence information. As such, when presence information is monitored by the user entity, subsequent changes may elicit events for which the user entity is notified. For example, if the monitored presence information changes from “away” to “playing Halo®,” an event may trigger thereby notifying the user entity of a change.

The presence system 204 may interface with a contact store 240 that stores information regarding other entities. The contact store 240 may store information for an entity such as one or more of a secure identifier, a human readable alias, an indicator of whether presence information for this entity is to be monitored, and an indicator of whether to allow this entity to obtain presence information regarding the user entity. An entity as represented in the contact store 240 may be referred to as a contact.

Each user entity may have one or more communication endpoints with which it is associated. Generally, different communication endpoints associated with a user entity may include different communication termination points associated with the entity, such as different computing systems. As an example, endpoints for a particular entity may include a desktop computer at work, a desktop computer at home, a personal digital assistant (PDA), etc. Optionally, different communication endpoints associated with a user entity may also include different software applications being executed by a single computing system. Endpoint information may include a peer name, a machine name, or a device type, to name a few.

The presence system 204 may also interface with a communication system 260, which is coupled to the communication network 202. The communication system 260 may establish connections between the system 200 and other peer computing systems associated with other entities. Establishing a connection may include, for example, one or more of determining an endpoint associated with an entity, resolving an address of the endpoint, authenticating communications, encrypting and decrypting communications, etc. In one implementation, the communication system 260 may include a Peer Name Resolution Protocol (PNRP), or similar. The PNRP may resolve a name (e.g., a peer name) for a contact to derive its IP address without reliance upon a Domain Name System (DNS), commonly used by server computers. In another implementation, the communication system 260 may interface with an authentication system 270 that is itself coupled to the contact store 240. In attempting to establish a connection with another computing system, the communication system 260 may receive from the other computing system an indication of an identifier associated with an entity. The authentication system 270 may then check whether information about the entity with the security identifier presented is stored in the contact store 240. If the identifier is not found in the contact store 240, the connection may be refused.

A connection may be secured. Establishing a connection and communicating over a connection may include, for example, one or more of utilizing a secure channel, utilizing secure socket layer (SSL) techniques, utilizing transport layer security (TLS) techniques, utilizing public/private key pairs, utilizing authentication techniques (e.g., X.509 certificates, encrypted signatures utilizing a pretty good privacy (PGP) program, etc.), utilizing a peer name resolution protocol (PNRP), transmission control protocol (TCP), internet protocol (IP), internet protocol version six (IPv6), etc. Resolving an address of an endpoint may include, for example, resolving a PNRP identifier to an IP address and a port.

A software application 280, or some other software module, may communicate with the presence system 204 to obtain presence information, capabilities information, and/or objects information associated with other user entities on the communication network 202. For example, the presence system 204 may provide a set of application programming interfaces (APIs) that permit software applications to request and receive information regarding presence, capabilities, and/or objects associated with other user entities. The presence system 204 may retrieve the requested information from the presence store 208, capabilities store 212, and/or the objects store 216. Additionally or alternatively, the presence system 204 could obtain requested information from the other user entities via the communication system 260 and the communication network 202. Generally speaking, “availability” may refer to presence information, capabilities and objects. A user entity has the ability to publish all, some, or none of this information.

An Invitation API 282 may permit an application 280 used by a user entity to invite other contacts or user entities of a serverless network to participate in a collaborative activity. The Invitation API 282 may employ the use of the Presence System 204 to determine contacts from the contact store 240. Additionally, the Presence System 204 may retrieve capability information located in the capability store 212. If a particular contact in the contact store 240 has no associated capability information, the Invitation API 282 or, alternatively, the Application 280 may employ a Capabilities API 284 to determine the capabilities of another user entity's endpoint. A capability may be a collaborative activity including any activity which is supported by an application on multiple endpoints. For example, a contact may support the activity of Halo® game play because the contact's endpoint has the Halo® gaming application installed. The Invitation API may allow the contact owner to determine other contacts on a serverless network that may support the activity of Halo® game-play.

A People Near Me (PNM) API 286 may permit an application 280 used by a user entity to determine other user entities, devices, or endpoints nearby. That is, determining which contacts, buddies, or endpoints match a particular proximity parameter. Proximity may include spatial references, such as contacts in a particular conference room, building, or state. Proximity may also include network references, such as contacts associated with a particular network subnet. Additionally, proximity may include nomenclature references, such as those contacts having, for example, the word “architect” in the contact name. However, in the broadest sense, PNM proximity may mean all people of a subnet. The PNM API 286 may store logical structures relating to contacts matching a particular proximity definition in a PNM cache 288.

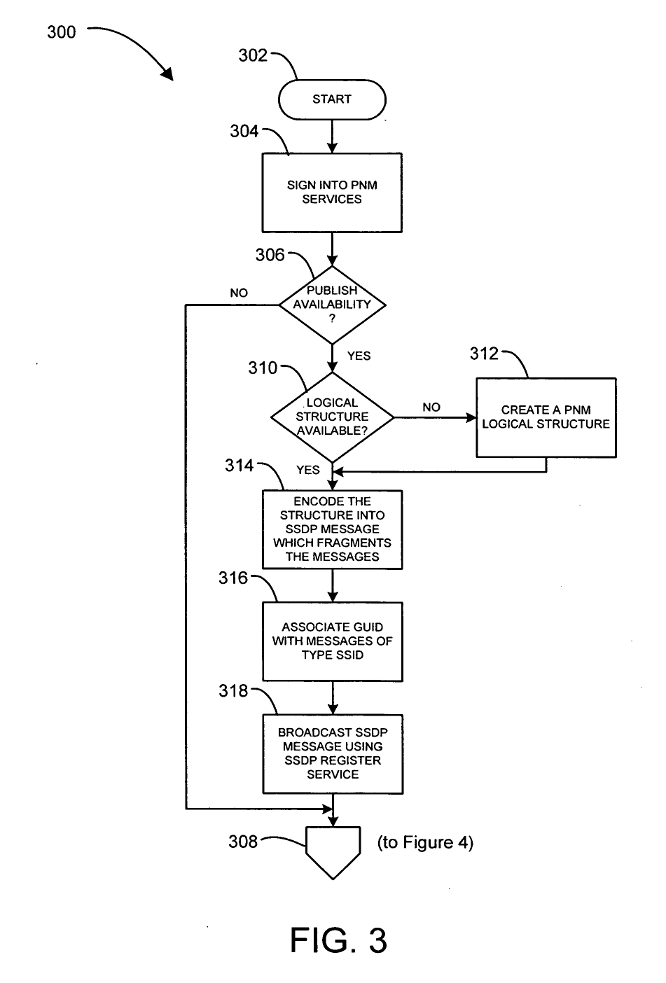

FIG. 3 may be an illustration of a method 300 in accordance with the claims. The method may begin at block 302 and proceed to initialize the PNM services at block 304. Authorization for a user entity to publish availability may be determined at block 306 and proceed to block 308 if authorization is not granted. As will be discussed later, a user entity choosing not to publish availability will prevent other user entities from discovering that user entity. However, the user entity that chooses not to publish may still determine whether other user entities or endpoints are nearby. Authorization may include a blanket policy of “allow” or “deny” the publication of availability information. Alternatively, authorization may be customized by the user entity allowing for various degrees of publication. For example, a user entity may authorize to publish certain availability information, but deny authorization to publish with respect to certain objects (e.g., files, file shares, etc.). A user entity may publish (in addition to presence) capabilities, user titles, random notes, etc. If authorization to publish is granted at block 306, the method 300 may then determine if a PNM logical structure is available at block 310. Alternatively, the method may first determine whether a user entity decides to publish availability followed by initialization (sign-in) of PNM services. A PNM logical structure may include a friendly name, peer identity information in XML (or other suitable) format, and a serverless network endpoint (e.g., an IP address and port). If necessary, a PNRP name resolution module of the Communication Module 260 may obtain an IP address and port. The friendly name may be a human readable string intended for presentation to a user entity. The peer identity information is obtained from the user identity's personal contact information, or any portion thereof the user entity may choose to publish. Other users of the serverless network may use this peer identity information to populate their contact store. If the logical structure is not available, one may be created at block 312, in which the method may call a function to retrieve the peer identity information. The method may further call a function to “package” the peer identity information in various formats, including XML and vCard.

The logical structure may be encoded as generic discovery protocol messages, PNRP, dynamic DNS, or Simple Service Discovery Protocol (SSDP) messages at block 314. By way of example, and not limitation, SSDP will be discussed in further detail. SSDP is a simple multicast protocol for broadcasting and discovering messages on a network, commonly implemented as a part of Universal Plug and Play (UPNP). SSDP is particularly useful when endpoints of a network have little or no static configuration. Additionally, the SSDP protocol does not require any server to aid in the process of discovery. SSDP messages may be fragmented to accommodate packet size requirements according to a Network Maximum Transmission Unit (MTU). Furthermore, the SSDP messages may be associated with a GUID such that other applications may identify the messages as type SSDP at block 316. After fragmentation, an SSDP registry function may broadcast the messages to the network at block 318.

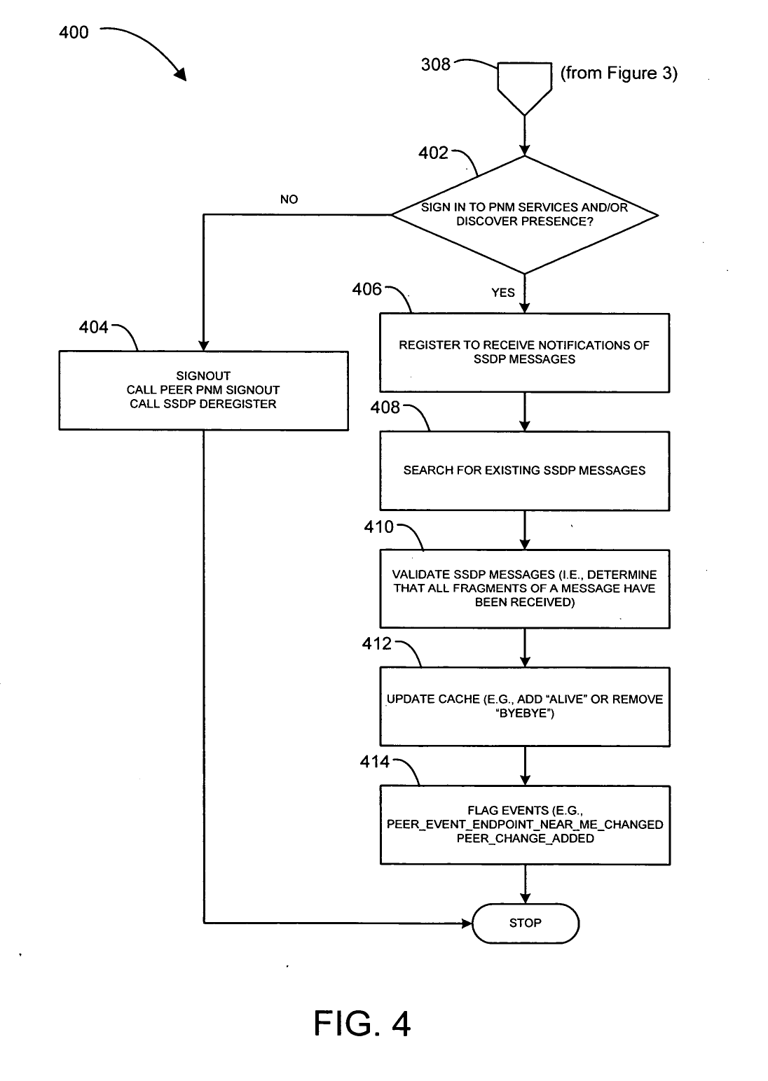

FIG. 4 may be an illustration of a method in accordance with the claims. The method may continue from block 308 (of FIG. 3) and determine whether the user entity wishes to discover “people near me” at block 402. As discussed earlier, if the user entity has not yet signed into PNM services (block 304), the user entity may make such choice at block 402. If not, then the method may sign-out from the PNM services and deregister the SSDP broadcast services at block 404. Alternatively, the method may employ a notification function to receive all messages of type SSDP (as identified by the message GUID) at block 406. As such, the method notifies the user entity when other users on the serverless network broadcast SSDP registry functions. Similarly, the method may employ an SSDP search function in which the cache on endpoints of other user entities is searched for stored messages of type SSDP at block 408. Such a search may employ any one of the previously mentioned descriptions of proximity, including, but not limited to, all people on a subnet, particular subgroups of people on a subnet, and particular name-matches of a subnet. Additionally, proximity may also include a geographical specification by locating those people who may be in close wireless proximity. SSDP message validation, at block 410, includes checking the message type for an indication of the other user entity's existence. For example, if an SSDP message on another user entity's cache is of type “alive,” then the calling user entity's cache 288 is updated to include that other user entity as a “person near me” at block 412. The calling user entity's cache may also be persisted. The method, however, is not limited to a “person,” but may include any entity at an endpoint. If an endpoint of a user entity leaves the serverless network in a controlled manner, then that endpoint may broadcast an SSDP message of type “bye-bye.” The remaining endpoints on the serverless network will then identify the SSDP message, verify it is of type “bye-bye”, and update the cache by removing that endpoint (also at blocks 410 and 412, respectively). Sometimes, however, an endpoint leaves the network abruptly without having the opportunity to broadcast an SSDP message of type “bye-bye.” As such, if a user entity's cache contains an SSDP message of an “alive” endpoint, but the SSDP search function fails to find that endpoint, then the cache of the calling user is updated to remove that endpoint at block 412. After the cache of the user/endpoint is updated, the method may flag a change event to notify a user of a new endpoint or a deleted endpoint at block 414.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of presence publication, comprising:
authorizing publication of presence at a first endpoint;
if the publication is authorized, assembling a presence data structure;
broadcasting the presence data structure from the first endpoint.

2. The method of claim 1 wherein the presence data structure comprises a friendly name, contact information, and endpoint information.

3. The method of claim 2, wherein the contact information is in at least one of an XML format or a vCard format.

4. The method of claim 2, wherein the endpoint information is obtained from a peer name resolution protocol.

5. The method of claim 1, wherein the presence data structure is encoded as at least one of a generic discovery protocol message or a simple service discovery protocol message.

6. The method of claim 5, further comprising associating a globally unique identifier with the discovery protocol messages.

7. The method of claim 1, wherein a user entity authorizes presence publication.

8. The method of claim 7, wherein the user entity sets at least one of a default parameter authorizing publication of all presence, some presence, or no presence.

9. A method of discovering user entities, comprising:
registering a first user entity at a first endpoint;
receiving messages identifying a second user entity;
validating the received messages;
storing the validation results in a discovery cache.

10. The method of claim 9, wherein registering comprises publishing simple service discovery protocol messages.

11. The method of claim 9, further comprising enumerating results of the discovery cache.

12. The method of claim 9, further comprising querying for a second user entity.

13. The method of claim 9, wherein the received messages are in XML format.

14. The method of claim 9, wherein the received messages comprise presence information.

15. The method of claim 14, wherein presence information comprises status of a second endpoint of the second user entity, contact identity information of the second user entity, and contact metadata of the second user entity.

16. The method of claim 9, wherein validation comprises identifying messages that indicate at least one of available user entities, or unavailable user entities.

17. The method of claim 16, further comprising adding available user entities to the discovery cache and removing unavailable user entities from the discovery cache.

18. The method of claim 9, wherein the messages are encoded as a simple service discovery protocol messages.

19. The method of claim 18, further comprising associating a globally unique identifier with the simple service discovery protocol messages.

20. The method of claim 9, wherein registering comprises permitting the first user entity to participate in message reception.
